(19) United States
(12) Patent Application Publication
(10) Pub. No.: US 2017/0120661 A1
(43) Pub. Date: May 4, 2017

(54) SCRATCH OFF LABEL FOR CARD

(71) Applicant: Diamond Graphics, Inc., Ramsey, MN (US)

(72) Inventor: David Milne, Cape Coral, FL (US)

(21) Appl. No.: 15/337,100

(22) Filed: Oct. 28, 2016

Related U.S. Application Data
(60) Provisional application No. 62/248,105, filed on Oct. 29, 2015.

(51) Int. Cl. B42D 25/378; G06K 19/04; G06K 19/06; B42D 25/20

(52) U.S. Cl. CPC B42D 25/378; B42D 25/20; G06K 19/041; G06K 19/06028

(57) ABSTRACT

A stored value card is shown. In one example a scratch off coating is disposed over a code on a stored value card. A color of the scratch off coating substantially matches a printed colored block located adjacent to the code. In one example, the scratch off coating and the printed colored block include colors other than grey. Assorted scratch off coating and printed color block colors may be used within a given number of cards.

### RELATED APPLICATION

This application claims priority to U.S. Provisional Patent Application No. 62/248,105, entitled “SCRATCH OFF LABEL FOR CARD,” filed on Oct. 29, 2015, which is incorporated herein by reference in its entirety.

### TECHNICAL FIELD

Embodiments described herein generally relate to scratch off labels on cards. Specifically examples include stored value cards with activations codes such as PIN numbers.

### BACKGROUND

Cards that include codes such as PIN numbers are frequently protected from theft using a scratch off label to cover a PIN number. A card must be activated before being used for a transaction. The eventual buyer of the card activates the card at the store of purchase. The buyer then scratches off the code, and is able to uniquely use the card for the amount of money stored on it at the time of purchase.

If a thief finds a way to discover the code prior to sale of the card, the card will be compromised. For security, customers should not buy cards with scratch off labels that have been compromised, and store clerks should not sell cards with scratch off labels that have been compromised. However resourceful thieves may attempt to scratch off labels before a card is sold, record the stolen code, and replace the scratch off label with a generic gray scratch off coating. It is desirable to make cards that have improved security against such theft.

### BRIEF DESCRIPTION OF THE DRAWINGS

FIG. 1 is a card including a code in accordance with some embodiments of the invention.

FIG. 2 is a card including a scratch off label in accordance with some embodiments of the invention.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

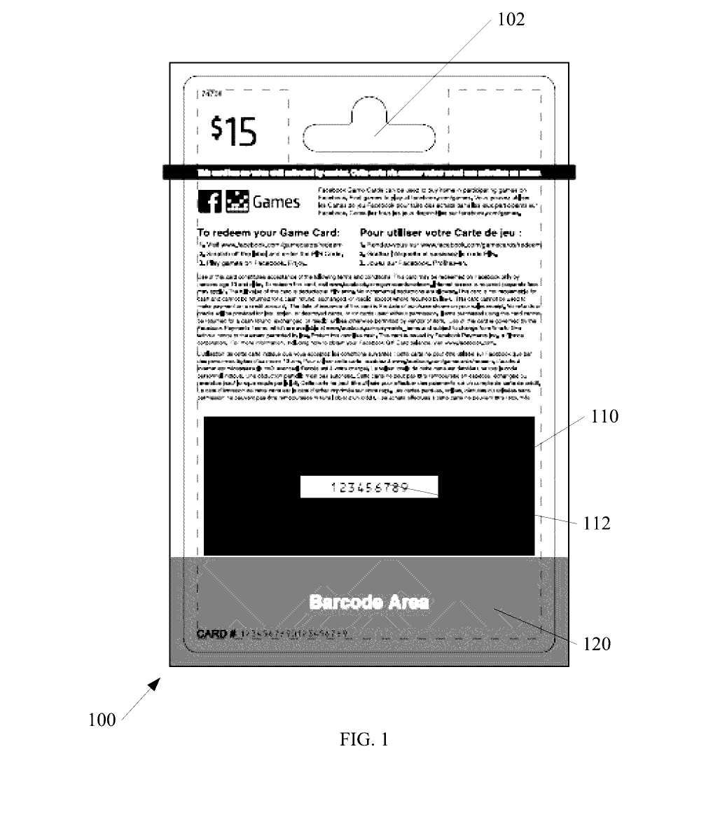

FIG. 1 shows a stored value card 100 according to one example of the invention. The stored value card 100 shown includes a code 112 printed on a face of the card 100, and a printed colored block 110 located adjacent to the code 112 on the face of the card.

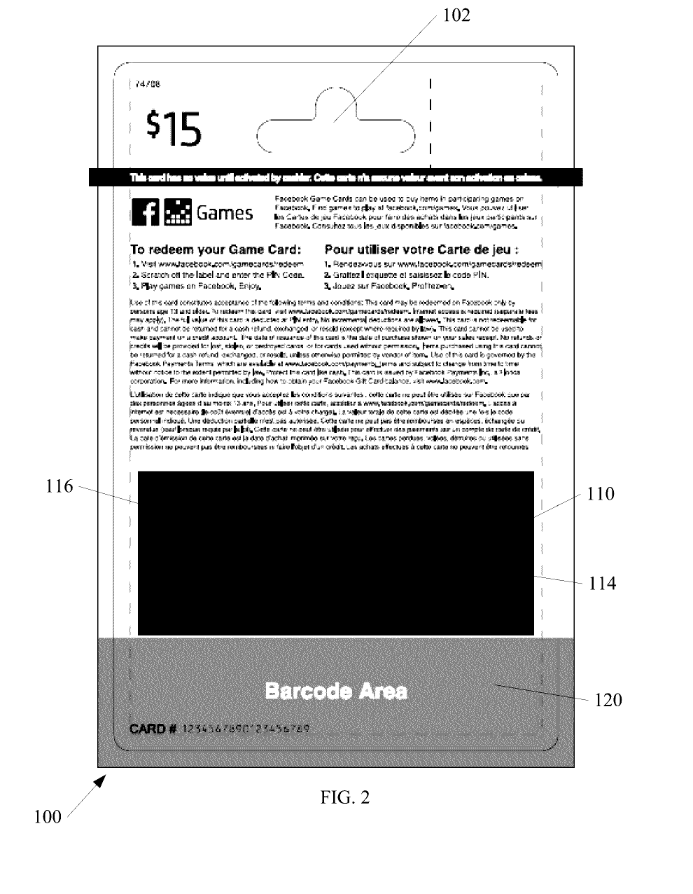

FIG. 2. shows a second view of the stored value card 100 from FIG. 1, with a scratch off coating 114 disposed over the code 112. In the example of FIG. 2, a color of the scratch off coating substantially matches the printed colored block 110. In one example, the scratch off coating 114 and the printed colored block 110 include colors other than grey, which is a common scratch off coating color, and may be more easily counterfeited.

A stored value card 100 as described provides improved security, because a thief is less likely to be able to duplicate the colored scratch off coating 114, and conceal that the code 112 has been compromised.

In one example, in a package of stored value cards 100, more than one color of scratch off coating 114 and matching printed colored block 110 are used. For example, a package of stored value cards 100 may include scratch off coatings 114 and matching printed colored blocks 110 of red, blue, green, etc. In one example darker saturated colors are used, as they may be more effective at concealing the code 11.

In one example, the more than one color of scratch off coating 114 and matching printed colored block 110 may be randomly shuffled within a given package of stored value cards 100. In other examples each package of stored value cards 100 may include a single color of scratch off coating 114 and matching printed colored block 110, while colors may vary from one package to the next. In this way, a retailer may choose to randomly assort colors on a display for consumers.

In one example the code 112 includes a PLN number. Other example codes may include letters a bar code, or other symbols. Most current codes 112 include a PIN number that a consumer may then enter when prompted, and use to identify themselves as the card owner. Other forms of a code 112 may be used in alternate security configurations.

In one example the code 112 is printed in a color that substantially matches the color of the scratch off coating. This optional feature may help keep the code 112 secret by reducing or eliminating color contrast that may make the code 112 visible through the scratch off coating 114. In one example the scratch off coating 114 further includes printed features 116 that further obscure the code 112, and make the scratch off coating 114 more difficult to counterfeit.

Further included in the example of FIGS. 1 and 2 the stored value card 100 may include a bar code 120. In one example, the bar code 120 is used to identify the card, and its stored value to a retailer. In other examples, a magnetic stripe may be used in place of the bar code 120.

The example stored value card 100 of FIGS. 1 and 2 shows a hang tag card with a hole 102 designed to hold the stored value card 100 on a retail display. As can be seen from the hole 102 of FIGS. 1 and 2, shapes of the hole 102 may vary, and any opening that is adapted to hold a card on a retail display may be used. Although a hole 102 is shown, the invention is not so limited. Other examples of a stored value card 100 may not include a feature for retail display.

In the example shown, the stored value card 100 is integrated, and formed from a single sheet of material such as cardboard or plastic. In other examples, a card may be formed separately from a carrier, and be attached to a carrier by an adhesive, shrink wrapping, or other methods. In one example the stored value card 100 may be integrally formed with a card carrier, and formed with a scoring or other line of weakness that allows the stored value card 100 to be broken out of the carrier and placed in a wallet, etc. In one example the stored value card 100 is a CR80 form factor. Other form factors are also within the scope of the invention.

To better illustrate the method and apparatuses disclose(herein, a non-limiting list of examples is provided here:

Example 1 includes a stored value card, including, a code printed on a face of the card, a printed colored block located adjacent to the code on the face of the card, and a scratch off coating disposed over the code, wherein a color of the scratch off coating substantially matches the printed colored block.

Example 2 includes the stored value card of example 1, wherein the code is a PIN number.

Example 3 includes the stored value card of any one of examples 1-2, wherein a color of the code substantially matches the color of the scratch off coating.

Example 4 includes the stored value card of any one of examples 1-3, further including a bar code region.

Example 5 includes the stored value card of any one of examples 1-4, further including a magnetic strip.

Example 6 includes a stored value card assembly including a card carrier having a stored value card coupled to the card carrier, a code printed on a face of the card, a printed colored block located adjacent to the code on the face of the card, and a scratch off coating disposed over the code, wherein a color of the scratch off coating substantially matches the printed colored block.

Example 7 includes the stored value card assembly of example 6, wherein the card carrier includes a hang tag for displaying the stored value card assembly.

Example 8 includes a package of stored value cards, comprising a plurality of cards, each card including, a code printed on a face of the card, a printed colored block located adjacent to the code on the face of the card, and a scratch off coating disposed over the code, wherein a color of the scratch off coating substantially matches the printed colored block, wherein the plurality of cards includes two or more different colors of printed colored blocks and substantially matching scratch off coatings.

Example 9 includes the package of stored value cards of example 8, wherein the code is a PM number.

Example 10 includes the package of stored value cards of any one of examples 8-9, wherein a color of each code substantially matches the color of each scratch off coating.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided, Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A stored value card, comprising:
a code printed on a face of the card;
a printed colored block located adjacent to the code on the face of the card; and
a scratch off coating disposed over the code, wherein a color of the scratch off coating substantially matches the printed colored block.

2. The stored value card of claim 1, wherein the code is a PIN number.

3. The stored value card of claim 1, wherein a color of the code substantially matches the color of the scratch off coating.

4. The stored value card of claim 1, further including a bar code region.

5. The stored value card of claim 1, further including a magnetic strip.

6. A stored value card assembly, comprising:
a card carrier having a stored value card coupled to the card carrier;
a code printed on a face of the card;
a printed colored block located adjacent to the code on the face of the card; and
a scratch off coating disposed over the code, wherein a color of the scratch off coating substantially matches the printed colored block.

7. The stored value card assembly of claim 6, wherein the card carrier includes a hang tag for displaying the stored value card assembly.

8. A package of stored value cards, comprising:
a plurality of cards, each card including:
a code printed on a face of the card;
a printed colored block located adjacent to the code on the face of the card; and
a scratch off coating disposed over the code, wherein a color of the scratch off coating substantially matches the printed colored block;
wherein the plurality of cards includes two or more different colors of printed colored blocks and substantially matching scratch off coatings.

9. The package of stored value cards of claim 9, wherein the code is a PIN number.

10. The package of stored value cards of claim 9, wherein a color of each code substantially matches the color of each scratch off coating.
